(19) United States
(12) Patent Application Publication
(10) Pub. No.: US 2014/0291237 A1
(43) Pub. Date: Oct. 2, 2014

(54) SCREEN

(71) Applicants: Janusz Krzysztof Fulara, Kallaroo (AU); Ryszard Stanislaw Rudas, Darlington (AU)

(72) Inventors: Janusz Krzysztof Fulara, Kallaroo (AU); Ryszard Stanislaw Rudas, Darlington (AU)

(73) Assignee: ANAECO LIMITED, Bentley, WA (AU)

(21) Appl. No.: 14/342,983

(22) PCT Filed: Sep. 6, 2012
(86) PCT No.: PCT/AU2012/001060

§ 371 Date: May 15, 2014

(30) Foreign Application Priority Data
Sep. 6, 2011 (AU) 2011903616

(51) Int. Cl. B01D 29/05; B01D 29/01

(52) U.S. Cl. CPC B01D 29/05; B01D 29/014
USPC 210/497.01; 210/499

(57) ABSTRACT

A screen (10, 50) comprising at least an outer and an inner layer (12, 14) of generally rod-shaped screen members (16, 18), the screen members each extending in a parallel but laterally off-set arrangement.

### FIELD OF THE INVENTION

The present invention relates to a screen. More particularly, the screen of the present invention is intended for use in drainage applications, having particular application as a drainage screen for organic waste treatment.

### BACKGROUND ART

It is known that solid organic waste material may be treated under either anaerobic or aerobic conditions to produce a bioactive, stable end product that, for example, may be used as compost for gardens. This process is achieved through the action of, respectively, anaerobic or aerobic microorganisms that are able to metabolise the waste material to produce the bioactive, stable end product.

It is also known that the aerobic decomposition of solid organic waste material takes place in the presence of oxygen. The temperature of the waste material rises as some of the energy produced during aerobic decomposition is released as heat, often reaching temperatures of approximately 75° C. under ambient conditions. The solid end product is often rich in nitrates which are a readily bio-available source of nitrogen for plants, making the end product particularly suitable as a fertiliser.

It is further known that the anaerobic digestion of solid organic waste material takes place in the absence of oxygen. Anaerobic microbial metabolism is understood to be optimised when the organic material is heated to temperatures at which mesophilic or thermophilic bacteria are operative. The process of anaerobic microbial metabolism results in the production of biogas, in turn predominantly methane and carbon dioxide. The solid product of the process is often rich in ammonium salts. Such ammonium salts are not readily bio-available and are, consequently, generally treated under conditions in which aerobic decomposition will occur. In this manner the material is used to produce a product that is bio-available.

Typically, systems for the biodegradation of organic waste material are directed to either aerobic or anaerobic processes. However, there are a small number of systems that have sought to combine both anaerobic and aerobic biodegradation processes. The processes of German Patent 4440750 and International Patent Application PCT/DE1994/000440 (WO 1994/024071) each describe the combination of an anaerobic fermentation unit and an aerobic composting unit. Importantly, these systems describe discrete and separate vessels for the aerobic and anaerobic biodegradation processes.

International Patent Application PCT/A000/00865 (WO 01/05729) describes an improved process and apparatus in which many of the inefficiencies of the previous processes and apparatus are overcome. The improved process and apparatus are characterised at a fundamental level by the sequential treatment of organic waste material in a single vessel, through an initial aerobic step to raise the temperature of the organic waste material, an anaerobic digestion step and a subsequent aerobic treatment step. During the anaerobic digestion step a process-water or inoculum containing micro, organisms is introduced to the vessel to create conditions suitable for efficient anaerobic digestion of the contents and the production of biogas. The introduced inoculum also aids in heat and mass transfer as well as providing buffer capacity to protect against acidification. Subsequently, air is introduced to the residues in the vessel to create conditions for aerobic degradation. It is further described that the water introduced during anaerobic digestion may be sourced from an interconnected vessel that has undergone anaerobic digestion.

The vessel used in such processes is often lined with a screen, provided as a sheet lining the interior of the vessel that is intended to prevent organic material from passing through but to allow the passage of fluids. The screens typically extend vertically within the vessel. To date wedge wire screens have been used, with the narrow edge of the wedge wire orientated to the wall of the vessel. However, wedge, wire screens often blind as a result of fibrous organic material becoming stuck thereon or therein, preventing the passage of fluids through the screen, at least at that position thereon. The physical construction of wedge wire screens, being thicker at one end and thinner at the other, also acts against the ready 2-way flow of fluids through the screen. 2-way flow of fluids is preferable as the digestion and composting processes that take place in the vessel benefit from the free passage of fluids.

In US Publication 2008/0033298 A1 there is shown a screen constructed of wedge wire arranged in a mesh that is used for the filtering of liquids with suspended solids to be removed, in a unilateral, or one-way, flow. The flat sides of the wedge wire are intended to be positioned against the liquid to be filtered. Further, the screen is in fact comprised of sheets of the wedge wire mesh folded on itself to create concentric or C-shaped screen arrangements to increase surface area. This screen does not overcome the problems experienced with wedge wire screens traditionally. Similarly, this screen is not suitable for facilitating the removal of moisture from a solid material, such as organic waste materials.

In U.S. Pat. No. 6,041,943 a rock separating or sorting apparatus is disclosed. The apparatus comprises two overlaid layers or gratings of parallel bars, substantially the same, that may be moved laterally with respect to one another so that the size of the sorting aperture may be varied. This apparatus does not act to screen fluid from solid material and does not present a solution to problems of the prior art noted above.

The screen of the present invention has as one object thereof to overcome substantially, or at least provide a useful alternative to, the abovementioned problems of the prior art.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the word “fluid” or variations thereof, will be understood to imply either a gas or a liquid of any type or composition, or any combination of gas or liquid. Further, it is to be understood to include gases, liquids, or combinations thereof, that may contain solids or liquids, suspended therein or otherwise conveyed thereby.

### DISCLOSURE OF THE INVENTION

In accordance with the present invention there is provided a screen comprising at least an outer and an inner layer of generally rod-shaped screen members, the screen members each extending in a parallel but laterally off-set arrangement.

Preferably, the generally rod-shaped screen members are circular in cross-section.

In one form of the present invention the rod shaped screen members are each held in position by two or more frame means.

Preferably, there are provided first and second end frames, between which the screen members extend.

Still preferably, the screen further comprises an intermediate frame arranged between the first and second end frames, screen members being provided extending between each end frame and the intermediate frame.

Still further preferably, the intermediate frame is positioned at a point substantially equidistant from each end frame.

In one form of the present invention the screen further comprises one or more intermediate support frames provided between the end frames and the intermediate frame.

Preferably, there are provided two intermediate support frames between each end frame and the intermediate frame, being spaced equidistant therebetween.

The rod shaped members of the outer layer are preferably tubular in construction. The rod shaped members of the outer layer preferably engage with stub members provided on the respective frame means. The rod shaped members of the inner layer are preferably of solid construction. The rod shaped members of the inner layer are preferably rigidly fixed to the frame means.

Preferably, rod shaped members of the outer layer are of a larger diameter than those of the inner layer.

In one form of the present invention the rod shaped members of the outer layer are provided with a diameter of about 12.7 mm whilst those of the inner layer are provided with a diameter of about 8 mm.

In a further form of the present invention the screen is provided so as to define an arc when viewed in transverse cross-section. In a further form of the present invention the screen is provided so as to define a generally flat plane.

### BRIEF DESCRIPTION OF THE DRAWINGS

The present invention will now be described, by way of example only, with reference to two embodiments thereof and the accompanying drawings, in which:

FIG. 1 is a plan view of a screen in accordance with a first embodiment of the present invention;

FIG. 2 is an end view of the screen of FIG. 1;

FIG. 3 is a cross-sectional side, view of the screen of FIG. 1;

FIG. 4 is a cross-sectional side view of a first end frame and its engagement with the rod shaped members;

FIG. 5 is a cross-sectional side view of an intermediate support frame and its engagement with the rod shaped members;

FIG. 6 is a cross-sectional side view of an intermediate frame and its engagement with the rod shaped members;

FIG. 7 is a cross-sectional side view of a second end frame and its engagement with the rod shaped members;

FIG. 8 is a plan view of the intermediate frame of FIG. 6;

FIG. 9 is cross-sectional end view of the screen of FIG. 1, showing the intermediate frame;

FIG. 10 is across-sectional end view of the screen of FIG. 1, showing the intermediate support frame of FIG. 5;

FIG. 11 is an end view of the screen of FIG. 1, showing the first end frame of FIG. 4;

FIG. 12 is a plan view of either the first or second end frame of FIG. 4;

FIG. 13 is a plan view of ascreen in accordance with a second embodiment of the present invention;

FIG. 14 is an end view of the screen of FIG. 13;

FIG. 15 is a cross-sectional side view of the screen of FIG. 13;

FIG. 16 is a cross-sectional side view of a first end frame and its engagement with the rod shaped members;

FIG. 17 is a cross-sectional side view of an intermediate support frame and its engagement with the rod shaped members;

FIG. 18 is a cross-sectional side view of an intermediate frame and its engagement with the rod shaped members;

FIG. 19 is a cross-sectional side view of a second end frame and its engagement with the rod shaped members;

FIG. 20 is a cross-sectional end view of the screen of FIG. 13, showing a first intermediate support frame;

FIG. 21 is a cross-sectional end view of the screen of FIG. 13, showing a second intermediate support frame;

FIG. 22 is a plan view of the first end frame of FIG. 13;

FIG. 23 is a plan view of the second end frame of FIG. 13;

FIG. 24 is a plan view of one half of the intermediate frame of FIG. 13; and

FIG. 25 is an end elevational view of the one half of the intermediate frame shown in FIG. 25.

### BEST MODE(S) FOR CARRYING OUT THE INVENTION

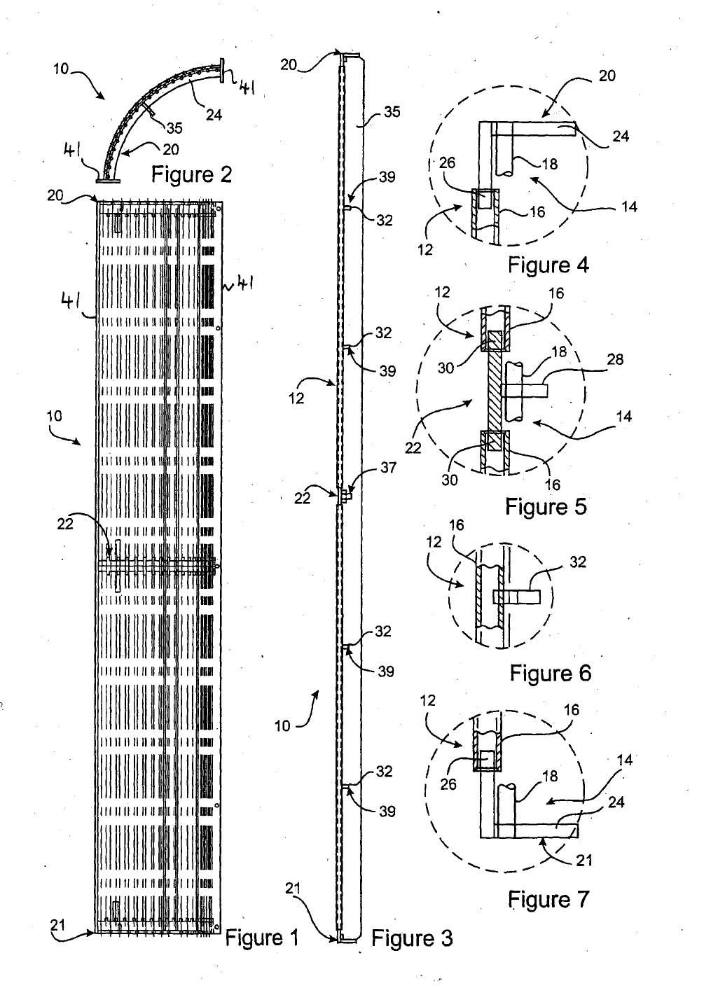

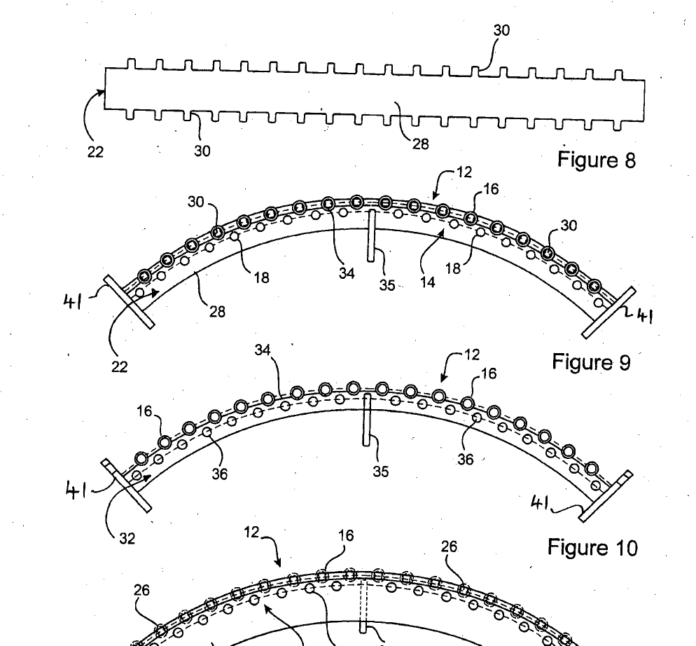

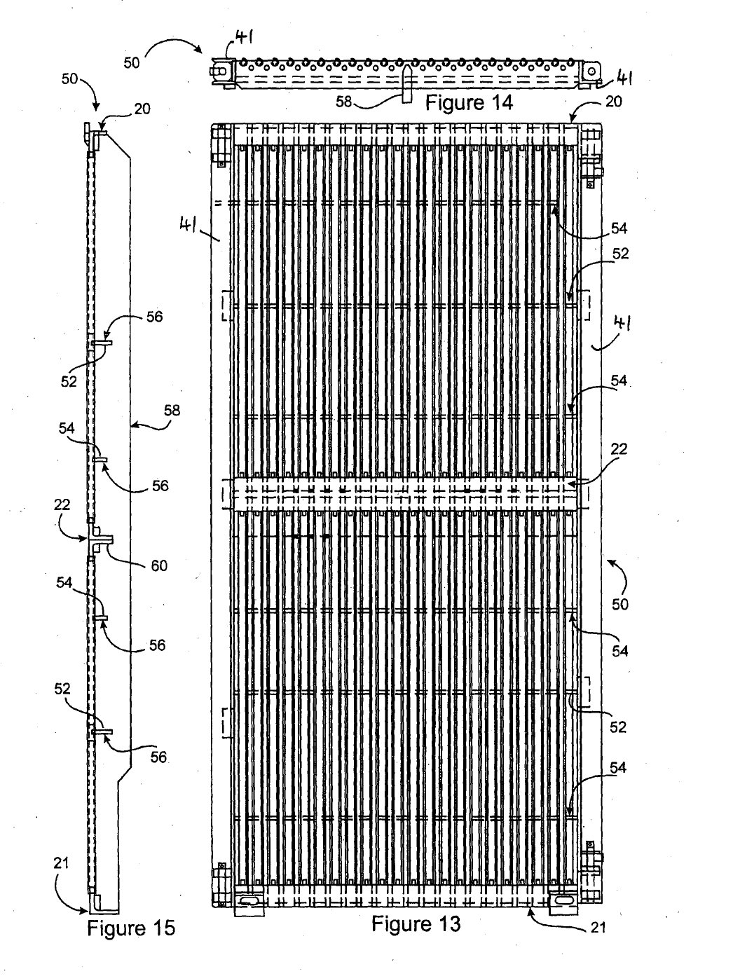

In FIGS. 1 to 12 there is shown a screen 10 in accordance with a first embodiment of the present invention. The screen 10 comprises an outer layer 12 and an inner layer 14 of generally rod-shaped screen members, as best seen in FIGS. 9 to 11. The generally rod shaped members of the outer layer 12 comprise hollow tubular, or cylindrical, members 16, whereas the generally rod shaped members of the inner layer 14 comprise solid bars 18 of circular cross-section.

The generally rod shaped members of the outer layer 12, the hollow tubular members 16, are laterally off-set with respect to the generally rod shaped members of the inner layer 14, being the solid bars 18. This arrangement is again best seen in FIGS. 9 to 11. As will become apparent hereinafter, the position of the generally rod shaped members of the outer layer 12 relative to those of the inner layer 14 are rigidly fixed.

The screen 10 further comprises several frame means, for example a first end frame 20, a second end frame 21, and an intermediate frame 22. Each end frame 20 and 21 is provided as a flanged member 24 having an arcuate profile when viewed in transverse cross-section, and a series of stub members 26 provided thereon. The stub members 26 are oriented in a single layer or arc, projecting in a single direction, as best seen in FIGS. 4, 7, 11 and 12.

Each intermediate frame 22 is provided as a flanged member 28, again having an arcuate profile to match that of the flanged member 24, and which flanged member 28 has a dual series of stub members 30, extending therefrom in substantially opposed manner, again describing a single layer or arc, as best seen in FIGS. 8 and 9.

The flanged member 24 allows the hollow tubular members 16 of the outer layer 12 to be seated about the stub members 26, as seen in FIG. 11. The bars 18 of the inner layer 14 are affixed directly to the flanged member 24. Similarly, the hollow tubular members 16 of the outer layer 12 are seated about the stub members 30 of the intermediate frame 22 and flanged member 28. Again, the bars 18 of the inner layer are affixed directly to the flanged member 28.

The frame means further comprises a number of intermediate support frames 32, as seen in FIGS. 1, 3, 5 and 10. The intermediate support frames 32 are again provided in an arcuate profile when viewed in transverse cross-section to match that of the end frames 20 and 21, and the intermediate frame 22. The intermediate support frames 32 support and cradle the outer layer 12 of generally rod shaped members and have a scalloped outer edge 34 provided thereon to facilitate this function. The intermediate support frames 32 have a series of apertures 36 provided therein to allow passage therethrough of the rod shaped members 18 of the inner layer 14. In this manner the inner layer 14 is also supported.

Two intermediate support frames 32 are positioned between each end frame 20 or 21 and the intermediate frame 22. The intermediate support frames 32 are spaced equidistance apart and in effect divide the distance between each end frame 20 and 21 and the intermediate frame 22 into three substantially equal portions, as best seen in FIGS. 1 and 3.

A brace member 35 is provided that extends longitudinally along the length of the screen 10, as best seen in FIGS. 2, 3, and 9 to 11. The brace member 35 is arranged at a lateral mid-point of the screen 10 and extends the length of the screen 10 from the first end frame 20 to the second end frame 21. The brace member 35 has provided therein a recess 37 to receive the intermediate frame member 22, again best seen in FIG. 3. The intermediate support frames 32 are received in appropriately sized slots 39 in the longitudinally disposed brace member 35. The brace member 35 provides rigidity to the screen 50 that may be necessary given the size thereof.

Additionally, elongate side frame members 41 are provided that extend the length of the screen 10, as best seen in FIGS. 2, 9 and 10.

The relative lateral off-setting of the screen members in the layers 12 and 14 creates a series of slots, in use. This in turn provides a screen 10 with a large percentage open area, in the order of 45% open area, that is suitable for fibrous organic material drainage. The percentage open area of prior art wedge wire screens is in the order of 25% open area typically, up to a maximum of 30%, although that level is very unusual in the prior art. The slots prevent the passage of large organic particles therethrough, whilst at the same time allowing the passage of fluids and small particles, such as those smaller than 6 mm.

The diameter of the hollow tubular members 16 is somewhat larger than that of the bars 18. For example, the external diameter of the hollow tubular members 16 may be about 12.7 mm, whilst the diameter of the bars 18 may be about 8 mm. It is to be understood that the members 16 and bars 18 may be provided of similar or identical diameter without departing from the scope of the present invention. It is further to be understood that the members 16 may be provided as solid members and, conversely, the bars 18 may be provided as hollow tubular members, again without departing from the scope of the present invention.

The screen 10 of the present invention is provided such that it may be used in conjunction with other screens 10 of the present invention to form a larger screen, such as may be provided within the reactor vessel of a waste treatment facility as described hereinabove. In such an arrangement the screens 10 will be arranged on their ends such that the slots defined between the screen members in the layers 12 and 14 extend vertically. Further, the screen 10 of the present invention may be arranged with three additional screens 10 to provide a cylindrical or tubular screen. Alternatively, cylindrical or tubular screens may, for smaller screen diameters, be constructed as a continuous 360° screen, rather than as a joined assembly of four quarter segments of 90°.

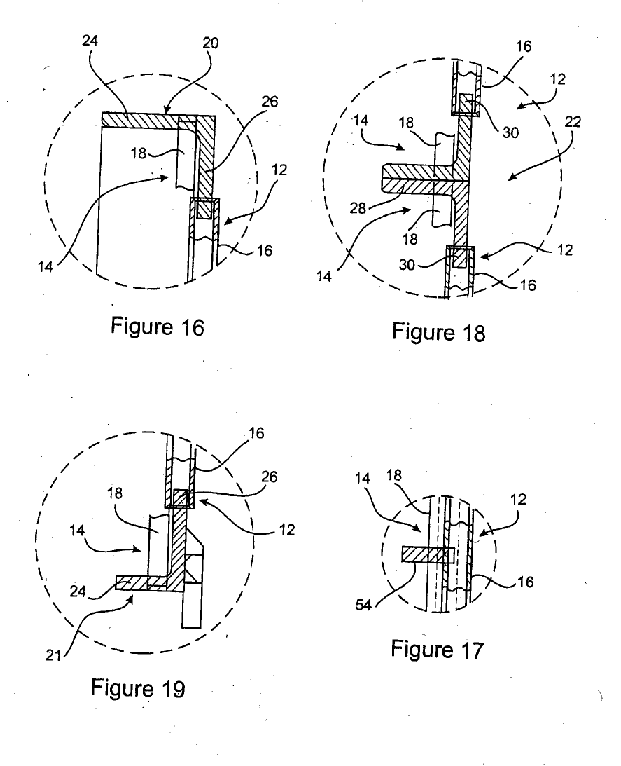

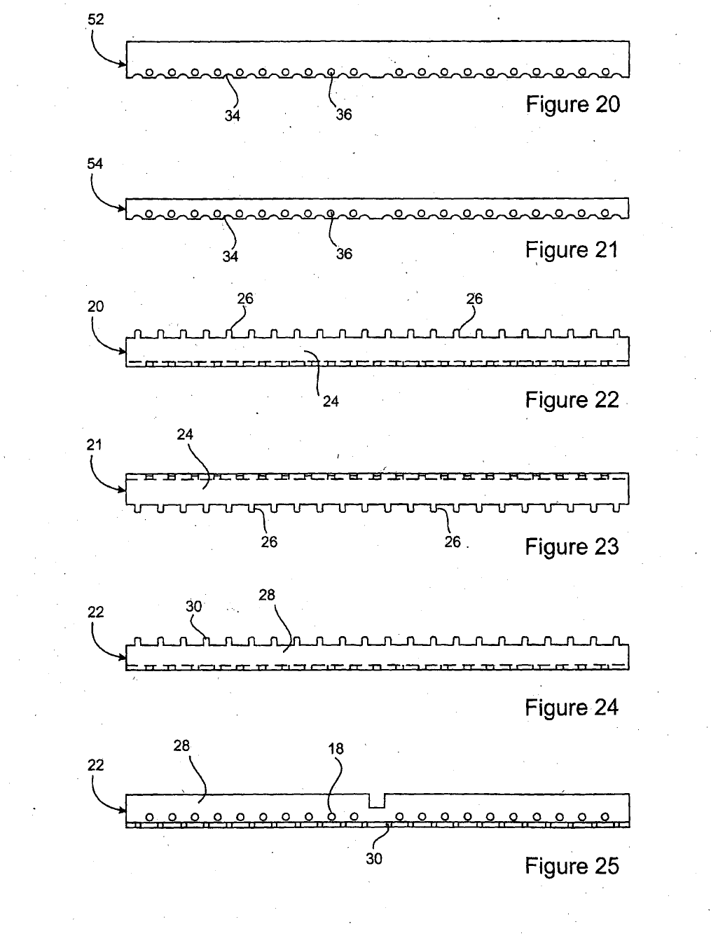

In FIGS. 13 to 25 there is shown a screen 50 in accordance with a second embodiment of the present invention. The screen 50 is substantially similar to the screen 10 described hereinabove and like numerals denote like parts. However, the screen 50 is provided in a substantially flat arrangement and described a generally flat plane, as can be seen with specific reference to FIGS. 14, 20, 21 and 25.

Further, there are provided a first form intermediate support frame 52 and a second form intermediate support frame 54, as seen in FIGS. 15, 20 and 21. The intermediate support frames 52 and 54 are functionally identical to the intermediate support frames 32 of the screen 10. However, the intermediate support frames 52 and 54 are provided in differing depths and are received in appropriately sized slots 56 in a longitudinally disposed brace member 58, best seen in FIG. 15. The brace member 58 is arranged at a lateral mid-point of the screen 50 and extends the length of the screen 50 from the first end frame 20 to the second end frame 21. The brace member 58 further has provided therein a recess 60 to receive the intermediate frame member 22, again best seen in FIG. 15. The brace member 58 provides rigidity to the screen 50 that may be necessary given the size thereof.

Additionally, elongate side frame members 41 are provided that extend the length of the screen 50, as best seen in FIGS. 13 and 14.

As noted above, the screens 10 and 50 of the present invention provide a screen having a higher ratio of open screen area to total geometrical screen size when compared with screens of the prior art. The percentage open area of the screens 10 and 50 is in the order of 45% open area. The percentage open area of prior art wedge wire screens is in the order of 25% open area typically, up to a maximum of 30%, although that level is very unusual in the prior art.

Whilst the rod-shaped screen members described hereinabove are circular or cylindrical in cross section, it is envisaged that the screen members may also be provided in a variety of other regular cross-sectional profiles, including for example square, hexagonal and octagonal profiles.

The screen 10 of the present invention is envisaged to provide substantially all the benefits of traditional wedge wire screens whilst overcoming substantially the disadvantages of such, particularly when applied in the reactor vessel of a waste treatment facility. For example, the screen 10 of the present invention is not as likely to be blinded by lodged organic material as is a wedge wire screen due to the rounded profile of the screen members. Further, the screen 10 of the present invention facilitates the 2-way flow of fluids therethrough, unlike the wedge wire screens of the prior art. However, the beneficial functions of the traditional wedge wire screen is retained, at least in part by the use of the varied diameter of the screen members in the outer and inner layers 12 and 14, respectively.

It is envisaged that the screen of the present invention has application not only in the waste treatment facilities noted above, but also in other industries and processes, including for example food processing, agriculture, landscaping and the like.

Modifications and variations such as would be apparent to the skilled addressee are considered to fall within the scope of the present invention.

1. A screen comprising at least an outer and an inner layer of generally rod-shaped screen members, the screen members each extending in a parallel but laterally off-set arrangement.

2. A screen according to claim 1, wherein the generally rod-shaped screen members are circular in cross-section.

3. A screen according to claim 1 or 2, wherein the rod shaped screen members are each held in position by two-or more frame means.

4. A screen according to any one of claims 1 to 3, wherein there are provided first and second end frames, between which the screen members extend.

5. A screen according to claim 4, wherein the screen further comprises an intermediate frame arranged between the first and second end frames, screen members being provided extending between each end frame and the intermediate frame.

6. A screen according to claim 5, wherein the intermediate frame is positioned at a point substantially equidistant from each end frame.

7. A screen according to any one of claims 4 to 6, wherein the screen further comprises one or more intermediate support frames provided between the end frames and the intermediate frame.

8. A screen according to claim 7, wherein there are provided two intermediate support frames between each end frame and the intermediate frame, being spaced substantially equidistant therebetween.

9. A screen according to any one of the preceding claims, wherein the rod shaped members of the outer layer are tubular in construction.

10. A screen according to any one of the preceding claims, wherein the rod shaped members of the outer layer engage with stub members provided on the respective frame means.

11. A screen according to any one of the preceding claims, wherein the rod shaped members of the inner layer are of solid construction.

12. A screen according to any one of claims 3 to 11, wherein the rod shaped members of the inner layer are rigidly fixed to the frame means.

13. A screen according to any one of the preceding claims, wherein the rod shaped members of the outer layer are of a larger diameter than those of the inner layer.

14. A screen according to any one of the preceding claims, wherein the rod shaped members of the outer layer are provided with a diameter of about 12.7 mm whilst those of the inner layer are provided with a diameter of about 8 mm.

15. A screen according to any one of the preceding claims, wherein the screen is provided so as to define an arc when viewed in transverse cross-section.

16. A screen according to any one of claims 1 to 14, wherein the screen is provided so as to define a generally flat plane.

17. A screen substantially as hereinbefore described with reference to FIGS. 1 to 12, or 13 to 25.
